(19) United States
(12) Patent Application Publication
(10) Pub. No.: US 2022/0119971 A1
(43) Pub. Date: Apr. 21, 2022

(54) Water-Based Anti-Corrosion Cutting Fluid for Electronic Device Housings

(71) Applicant: Hewlett-Packard Development Company, L.P., Spring, TX (US)

(72) Inventors: Kuan-Ting Wu, Taipei City (TW); Chi Hao Chang, Taipei City (TW); Chienchih Chiu, Taipei City (TW)

(73) Assignee: Hewlett-Packard Development Company, L.P., Spring, TX (US)

(21) Appl. No.: 17/425,146

(22) PCT Filed: May 9, 2019
(86) PCT No.: PCT/US2019/031404

§ 371 Date: Jul. 22, 2021

(51) Int. Cl. C25D 1/14; C25D 13/20; C25D 13/02; H01M 50/124

(52) U.S. Cl. CPC C25D 1/14; H01M 50/124; C25D 13/02; C25D 13/20

(57) ABSTRACT

In one example, a method for manufacturing an electronic device housing is described. A coating layer may be formed on a surface of a metal substrate. Further, an edge region of the metal substrate may be chamfered by applying water-based anti-corrosion cutting fluid to form an exposed surface portion of the metal substrate. On the exposed surface portion, a transparent protective passivation layer may be formed. Furthermore, a first electrophoretic deposition layer may be formed on the transparent protective passivation layer.

### BACKGROUND

Metal housings with lightweight and high rigidity properties have become popular since the portable electronic products are developed to be lighter and smaller. In such requirements, metal housings may be manufactured using metal substrates such as magnesium alloy, aluminum alloy, or the like, which may be of low density, high specific strength, good heat dissipation, anti-electromagnetic interference capability, and good shock absorption.

### BRIEF DESCRIPTION OF THE DRAWINGS

Examples are described in the following detailed description and in reference to the drawings, in which:

FIG. 1 illustrates an example flowchart for manufacturing an electronic device housing;

FIG. 2 illustrates another example flowchart for making a casing for an electronic device;

FIG. 3 illustrates yet another example flowchart for making a casing for an electronic device;

FIG. 4 illustrates a top view of an example electronic device housing, depicting chamfered edge regions; and

FIGS. 5, 6, and 7 illustrate example processes for forming a transparent protective passivation layer and an electrophoretic deposition layer on a chamfered edge region of a metal substrate.

### DETAILED DESCRIPTION

Housings for electronic devices such as mobile phones, laptop computers, music players, personal digital assistants, global positioning system devices, and the like can be made by metal. Because of the light weight and high mechanical strength, magnesium alloys are suitably used in electronic device housings, for instance. However, magnesium alloys may have poor color stability, hardness, and chemical resistance. Therefore, it may be difficult to fabricate metallic luster feeling at chamfered surfaces of the magnesium alloy housings as the magnesium alloys can be oxidized on the surface. Further, it may be difficult to obtain multiple colors on the chamfered surfaces of the magnesium alloy housings using spray painting process, for instance.

Further, due to active chemical nature of the magnesium alloy, it may be difficult to process the magnesium alloy as magnesium ions may be dissolved in cutting fluid (i.e., during computer numerical control (CNC) diamond cut process) in significant amount. Also, the chamfered surfaces formed by applying existing cutting fluid may be oxidized after 1-2 hours of exposure to the environments.

Examples described herein may provide a method for manufacturing an electronic device housing. In one example, a coating layer may be formed on a surface of a metal substrate. Further, an edge region of the metal substrate may be chamfered by applying water based anti-corrosion cutting fluid to form an exposed surface portion of the metal substrate. On the exposed surface portion, a transparent protective passivation layer may be formed. Furthermore, an electrophoretic deposition layer may be formed on the transparent protective passivation layer.

Examples described herein may provide metallic lustering chamfer surfaces (e.g., glossy or naturally metallic luster surfaces) at edge regions of the electronic device housings. Further, examples described herein may enhance aesthetic appearance of the electronic device housings by providing different colors at the chamfered edge regions of the metal surfaces. Furthermore, example transparent protective passivation layer and electrodeposition layer described herein may prevent or resolve stain and corrosion issues of the metal substrate exposed through the exposed surface portion.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described is included in at least that one example, but not necessarily in other examples.

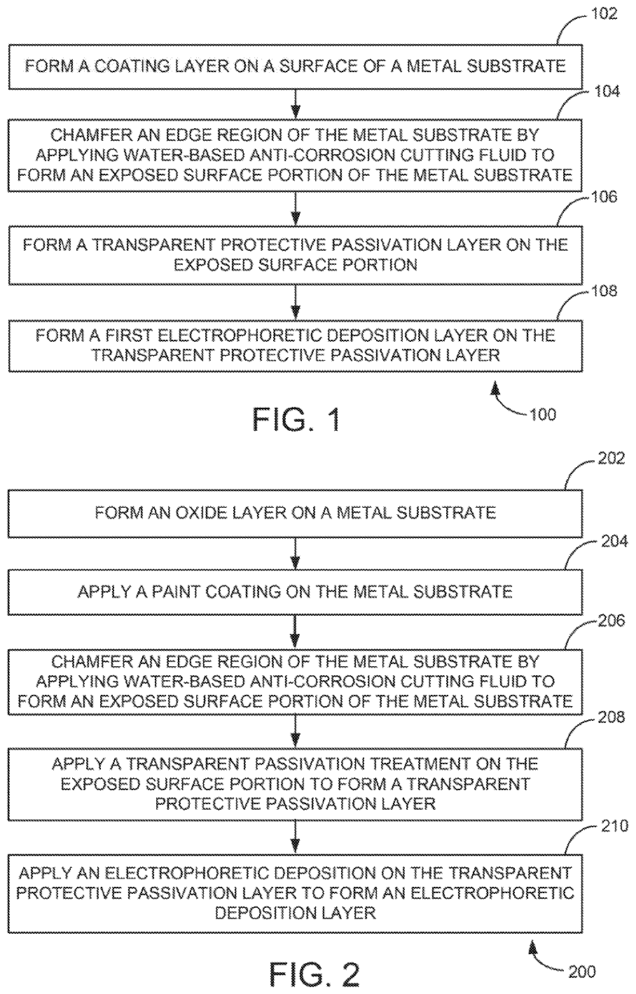

Turning now to the figures, FIG. 1 illustrates an example flowchart 100 for manufacturing an electronic device housing. Example electronic device housing may be a smart phone housing, tablet or notebook personal computer housing, digital camera housing, or the like. Further, example electronic device housing may be a display housing that houses a display, a keyboard housing that houses a keyboard, or a combination thereof.

At 102, a coating layer may be formed on a surface of a metal substrate. Example metal substrate may include aluminum, magnesium, lithium, zinc, titanium, aluminum alloy, magnesium alloy, lithium alloy, zinc alloy, titanium alloy, or combinations thereof. In one example, the coating layer may be an oxide layer formed by applying one of a micro-arc oxidation treatment and a passivation treatment on the surface of the metal substrate. In one example, the micro-arc oxidation treatment and the passivation treatment can be electrochemical surface treatment processes for generating oxide coatings on the metal substrate.

For example, the micro-arc oxidation process may refer to a process for generating oxide coatings on the metal substrate. During the micro-arc oxidation process, the metal substrate may be placed in an electrolytic solution including electrolytes selected from a group consisting of sodium silicate, sodium phosphate, potassium fluoride, potassium hydroxide, sodium hydroxide, fluorozirconate, sodium hexametaphosphate, sodium fluoride, aluminum oxide, silicon dioxide, ferric ammonium oxalate, phosphoric acid salt, and polyethylene oxide alkylphenolic ether. The electrolyte may be present in a concentration of 0.05 to 15% by weight based on the total weight of the electrolytic solution and a voltage in the range of 200-600 volts may be passed across the electrolytic solution with the metal substrate (e.g., magnesium alloy substrate) placed in the electrolytic solution to form a micro-arc oxidized layer (i.e., the oxide layer). In one example, the voltage may be applied for about 3 to 20 minutes and the micro-arc oxidation process can be carried out at a temperature between room temperature and 45° C. The thickness of the micro-arc oxide layer can be in the range of 3-15 μm. The micro-arc oxidation properties may include wearing resistance, corrosion resistance, high hardness, and electrical insulation.

Similarly, the passivation treatment may refer to a process of treating or coating the metal substrate to reduce the chemical reactivity of a surface of the metal substrate. For example, the passivation treatment may involve creation of an outer layer of shield material around the metal substrate to make the metal substrate “passive”, i.e., less affected or corroded by the environment.

In another example, the coating layer may be a second electrophoretic deposition layer formed by applying an electrophoretic deposition on the surface of the metal substrate. The electrophoretic deposition may be a process in which the metal substrate is placed in a fluid and a potential difference is applied to cause charged particles in the fluid to be deposited on the metal substrate.

At 104, an edge region of the metal substrate may be chamfered by applying water-based anti-corrosion cutting fluid to form an exposed surface portion of the metal substrate. In one example, the edge region may include an outer periphery of the metal substrate, an inner periphery of the metal substrate, or a combination thereof. The outer periphery may refer to a boundary region or a side wall of the metal substrate and the inner periphery may refer to an edge surface defining an opening within the metal substrate. For example, the opening may correspond to a touchpad, keyboard, fingerprint scanner, or the like.

Example water based anti-corrosion cutting fluid may include components (e.g., with weight percentage) such as alcoholic agent (e.g., phosphate, and the like) of about 5-40%, organic amine (e.g., diethanolamine, diglycolamine, ethylenediamine, triethanolamine, and the like) of about 3-15%, carboxylate salt (e.g., acetate, oxalate, and the like) of about 5-30%, surfactant of about 1-5%, and water of about 55-85%. In one example, the edge region may be chamfered using a CNC machining (e.g., a CNC diamond cut process), a laser engraving process, or the like. In this example, the edge region of the metal substrate may be chamfered by the CNC machining while applying or spraying the water based anti-corrosion cutting fluid.

At 106, a transparent protective passivation layer may be formed on the exposed surface portion. Example transparent protective passivation layer may include a complex of a metal ion, an organic acid, and a chelating agent. Example chelating agent may include ethylenediaminetetraacetic acid (EDTA), ethylenediamine, nitrilotriacetic acid (NTA), diethylenetriaminepenta (methylenephosphonic acid) (DTPPH), nitrilotris (methylenephosphonic acid) (NTMP), 1-hydroxyethane-1,1-diphosphonic acid (HEDP), sulfuric acid, phosphoric acid, or any combination thereof. Example metal ion may be aluminum ion, nickel ion, tin ion, indium ion, chromium ion, zinc ion, or any combination. Example organic acid may include lactic acid, acetic acid, formic acid, oxalic acid, and the like. In one example, transparent protective passivation layer may have a thickness in a range of 30 nm to 3 μm.

In one example, the exposed surface portion may be cleaned by ultrasonic vibration cleaning prior to forming the transparent protective passivation layer. Example ultrasonic vibration cleaning may include cleaning the exposed surface portion with deionized water for about 30 seconds to 180 seconds. The exposed surface portion may be cleaned to remove oil and oxides from the exposed surface portion.

At 108, a first electrophoretic deposition layer may be formed on the transparent protective passivation layer. In one example, the electrophoretic deposition may be used to impart a certain desired property, such as a hardness or toughness, or a certain desired appearance to the metal substrate. Thus, the transparent protective passivation layer and the electrophoretic deposition layer on the chamfered edge region may provide a shiny, flat, and smooth metallic appearance. Thereby, the chamfered edge region may provide an aesthetically appealing appearance for the electronic device housing.

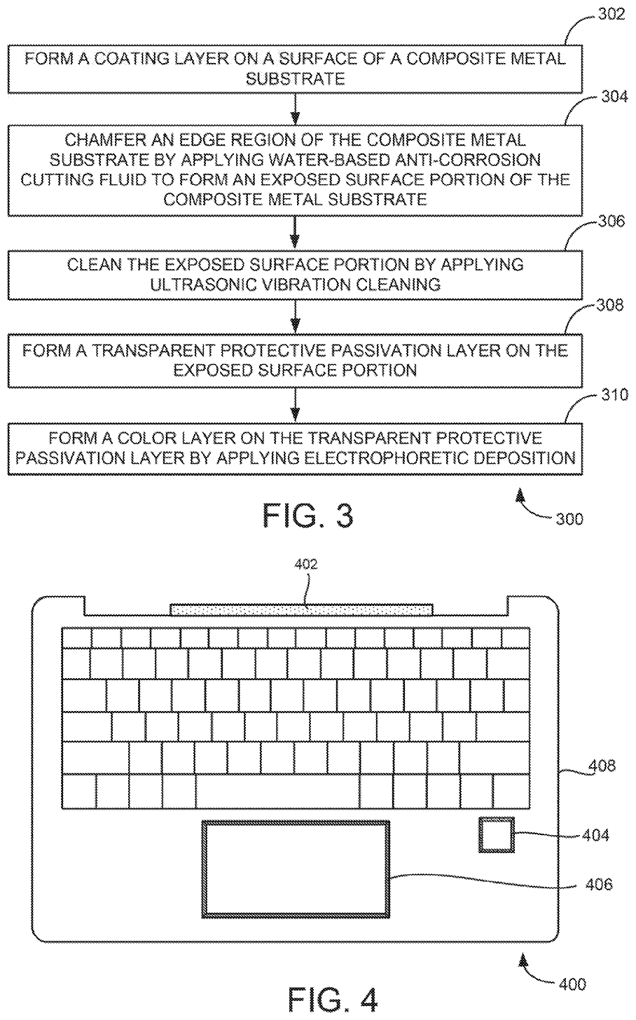

FIG. 2 illustrates another example flowchart 200 for making a casing for an electronic device. Example casing or electronic device housing may be a display housing that houses a display, a keyboard housing that houses a keyboard, or a combination thereof. At 202, an oxide layer may be formed on a metal substrate.

At 204, a paint coating may be applied on the metal substrate. In one example, applying the paint coating on the metal substrate may include applying a primer coat on an outer surface of the metal substrate. Example primer coat may include polyurethane. In one example, primer coat may have a thickness in a range of 5-20 μm. Further, the paint coating may include a base coat formed on the primer coat. Example base coat may include polyurethane in combination with at least one pigment selected from a group consisting of carbon black, titanium dioxide, clay, mica, talc, barium sulfate, calcium carbonate, synthetic pigment, metallic powder, aluminum oxide, an organic powder, an inorganic powder, plastic bead, color pigments, and dyes. In one example, base coat may have a thickness in a range of 10-20 μm.

Furthermore, the paint coating may include one of an ultraviolet top coat and a thermal-cured polyurethane top coat on the base coat. Example ultraviolet top coat may include polyacrylic, polyurethane, urethane acrylates, acrylic acrylates, epoxy acrylates, or any combination thereof. In one example, the ultraviolet top coat may have a thickness in a range of 10-25 μm. Example thermal-cured polyurethane top coat may include hydroxyl-functional acrylic polymers for formulating urethane coatings. In one example, paint coating may include any combination of the primer coat, the base coat, and the ultraviolet top coat or the thermal-cured polyurethane top coat.

At 206, an edge region of the metal substrate may be chamfered by applying water-based anti-corrosion cutting fluid to form an exposed surface portion of the metal substrate. In one example, chamfer may be formed on side walls (e.g., edge regions) of the metal substrate. Further, the chamfer can have any suitable shape (e.g., chamfer, round, ogee, or the like), thus giving the edge regions of the metal substrate any suitable cross-sectional shape. For example, the chamfer may provide aesthetically and tactilely pleasing feature for the electronic device housing. Further, after the chamfer is formed on the edge region, the metal substrate may be exposed to additional finishing processes such as a transparent passivation treatment and an electrophoretic deposition.

At 208, the transparent passivation treatment may be applied on the exposed surface portion to form a transparent protective passivation layer. In one example, the transparent passivation treatment may be applied by applying a passivation solution including a complex of a metal ion, an organic acid, and a chelating agent on the exposed surface portion. At 210, an electrophoretic deposition may be applied on the transparent protective passivation layer to form an electrophoretic deposition layer. The electrophoretic deposition may be a process in which the metal substrate is placed in a fluid and a potential difference is applied to cause charged particles in the fluid to be deposited on the transparent protective passivation layer.

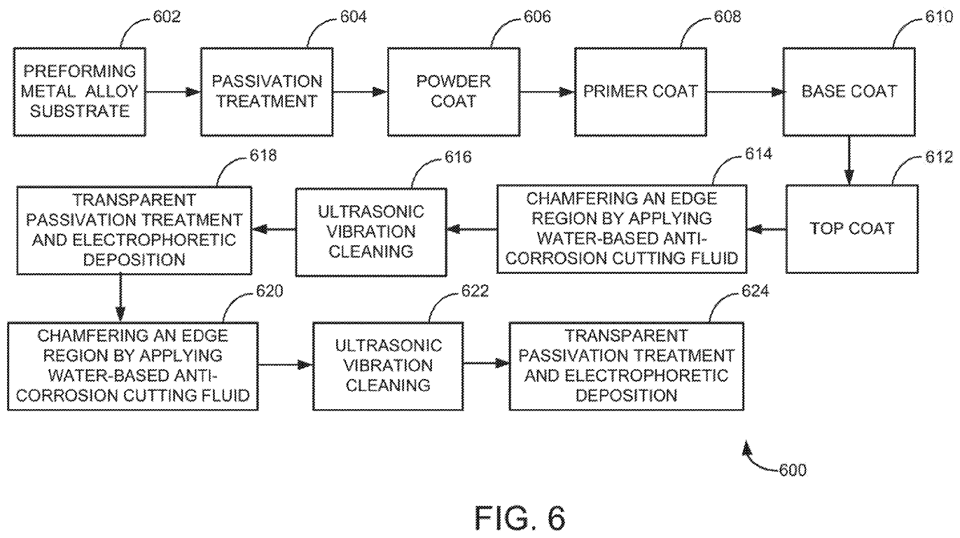

In one example, the electrophoretic deposition layer on the chamfered edge region may include a color different from that of the oxide layer formed on the surface of the metal substrate. Example casing having a color layer on the chamfered edge region is depicted in FIG. 4.

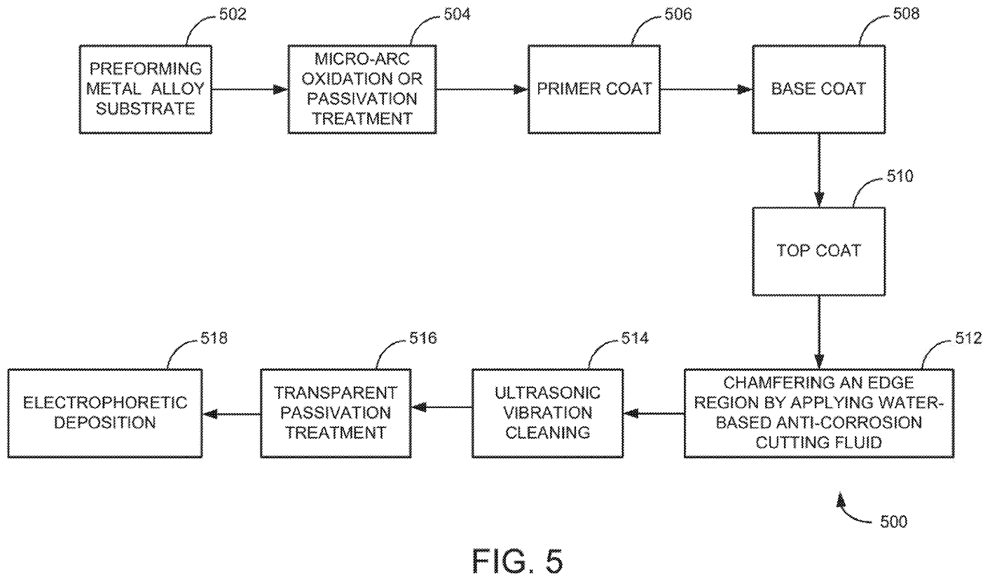

FIG. 3 illustrates yet another example flowchart 300 for making a casing for an electronic device. At 302, a coating layer may be formed on a surface of a composite metal substrate. In one example, the coating layer may be a micro-arc oxidation layer, a passivation layer, or an electrophoretic deposition layer. Example composite metal substrate may include a metal-plastic composite substrate, a metal-carbon fiber composite substrate, or the like.

At 304, an edge region of the composite metal substrate may be chamfered by applying water-based anti-corrosion cutting fluid to form an exposed surface portion of the composite metal substrate. In one example, a paint coating may be applied on an outer surface of the composite metal substrate prior to chamfering the edge region of the composite metal substrate. For example, the paint coating may include a powder coating, a primer coating, a base coating, an ultraviolet top coating, or any combination thereof. Example paint coating is described in FIGS. 2 and 6.

At 306, the exposed surface portion may be cleaned by applying ultrasonic vibration cleaning. At 308, a transparent protective passivation layer may be formed on the exposed surface portion. At 310, a color layer may be formed on the transparent protective passivation layer by applying electrophoretic deposition. In one example, the color layer on the transparent protective passivation layer may be a color different from that of the coating layer formed on the surface of the composite metal substrate. Example casing having different color layers on different chamfered edge regions is depicted in FIG. 4.

FIG. 4 illustrates a top view of an example electronic device housing or casing 400, depicting chamfered edge regions (e.g., 402, 404, and 406). In the example shown in FIG. 4, chamfered edge region 402 may correspond to an outer periphery of a metal substrate 408, chamfered edge region 404 may correspond to a boundary defining a finger print scanner within metal substrate 408, and chamfered edge region 406 may correspond to a boundary defining a touchpad within metal substrate 408.

In one example, the electrophoretic deposition may provide multi-color metallic luster finishing at chamfered edge regions 402, 404, and 406 of casing 400. Each of the chamfered edge regions 402, 404, and 406 can have a different color layer formed using the example methods described in FIGS. 1-3. For example, the electrophoretic deposition may utilize about 0.3-15.0 weight percentage of red dye (e.g., Alexa Fluor 594 dye and Texas Red) or red pigment (e.g., Pigment Red 168 MF) in the formulation to form red metallic luster on chamfered edge region 402 corresponding to side wall. In another example, the electrophoretic deposition may utilize about 0.3-15.0 weight percentage of yellow dye (e.g., Quinoline Yellow WS) or yellow pigment (e.g., Pigment Yellow 191) in the formulation to form yellow metallic luster, for instance, on chamfered edge region 404 corresponding to fingerprint scanner. Similarly, transparent metallic luster may be formed on chamfered edge region 406 corresponding to touchpad. Thus, multiple electrophoretic deposition treatments may be applied at multiple chamfered edge regions to form transparent, semi-transparent, and sparkling colors.

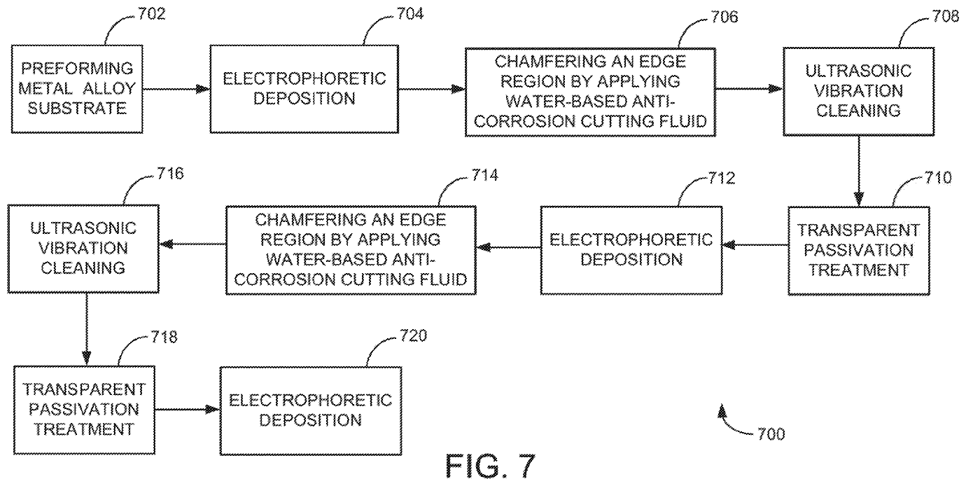

FIG. 5 illustrates an example process 500 for forming a transparent protective passivation layer and an electrophoretic deposition layer on a chamfered edge region of a metal substrate. At 502, a metal alloy substrate or metal substrate (e.g., magnesium alloy substrate) may be pre-formed. For example, preforming the metal alloy substrate may include forging, die casting, or CNC machining the metal substrate into a desired shape and then cleaning the forged, die casted, or CNC machined metal alloy frame. The cleaning of the metal substrate may include a pre-cleaning process, such as an alkaline cleaning process, degreasing cleaning process, an acidic cleaning process, or any combination thereof.

At 504, a micro-arc oxidation or passivation treatment may be applied on the metal substrate to form a coating layer on a surface of the metal substrate. In one example, the coating layer may be formed to reduce the chemical reactivity of the surface of the metal substrate. At 506, a primer coat may be applied on an outer surface of the metal substrate. At 508, a base coat may be applied on the primer coat. At 510, one of an ultraviolet top coat and a thermal-cured polyurethane top coat may be applied on the base coat. Example paint coating is described in FIGS. 2 and 6.

At 512, an edge region of the metal substrate may be chamfered by applying water-based anti-corrosion cutting fluid to form an exposed surface portion of the metal substrate. In one example, the edge region may be chamfered using a CNC machining, a laser engraving process, or the like.

At 514, the exposed surface portion may be cleaned by ultrasonic vibration cleaning. Example ultrasonic vibration cleaning is described in FIG. 1. At 516, a transparent protective passivation layer may be formed on the exposed surface portion by applying a transparent passivation treatment. In one example, the transparent protective passivation layer may be formed on the exposed surface portion by applying a passivation solution including a complex of a metal ion, an organic acid, and a chelating agent. Example transparent protective passivation layer is explained in FIG. 1.

At 518, an electrophoretic deposition layer may be formed on the transparent protective passivation layer by applying electrophoretic deposition. The electrophoretic deposition may include a polymer in combination with particles selected from the group including inorganic and metallic particles.

FIG. 6 illustrates another example process 600 for forming a transparent protective passivation layer and an electrophoretic deposition layer on different chamfered regions of a metal substrate. At 602, a metal alloy substrate or metal substrate (e.g., magnesium alloy substrate) may be pre-formed. At 604, a passivation treatment may be applied on the metal substrate to form a coating layer on a surface of the metal substrate.

At 606, a powder coat may be applied on an outer surface of the metal substrate. For example, the powder coat may include resins such as acrylics, polyurethanes, polyamide, fluoropolymer, polyester, and epoxies, which may contain fillers such as talc, clay, titanium dioxide, aluminum powder, barium sulfate, mica, graphene, dye, and color pigment. The powder coat may have a thickness in a range of 20-60 μm.

At 608, a primer coat may be applied on the powder coat. For example, applying the primer coat may include applying polyurethane mixture on the powder coat, and subsequently drying the polyurethane mixture at a temperature of 60-80° C. for about 15-40 minutes. The primer coat may have a thickness in a range of 5-20 μm.

At 610, a base coat may be applied on the primer coat. For example, applying the base coat on the primer coat may include applying a mixture of polyurethane in combination with at least one pigment selected from a group consisting of carbon black, titanium dioxide, clay, mica, talc, barium sulfate, calcium carbonate, synthetic pigment, metallic powder, aluminum oxide, an organic powder, an inorganic powder, plastic bead, color pigments, and dyes, and subsequently drying the mixture at a temperature of 60-80° C. for about 15-40 minutes. The base coat may have a thickness in a range of 10-20 μm.

At 612, one of an ultraviolet top coat and a thermal-cured polyurethane top coat may be applied on the base coat. For example, applying the ultraviolet top coat on the base coat may include applying a mixture selected from the group consisting of polyacrylic, polyurethane, urethane acrylates, acrylic acrylates, and epoxy acrylates, and subsequently drying the mixture at a temperature of 50-60° C. for about 10-15 minutes followed by ultraviolet exposure in a range between 700-1,200 mJ/cm2 for 10-30 seconds. The ultraviolet top coat may have a thickness in a range of 10-25 μm. Example thermal-cured polyurethane top coat may include hydroxyl-functional acrylic polymers for formulating urethane coatings.

At 614, a first edge region of the metal substrate may be chamfered by applying water-based anti-corrosion cutting fluid to form an exposed surface portion of the metal substrate. At 616, the exposed surface portion may be cleaned by ultrasonic vibration cleaning. At 618, a transparent protective passivation layer may be formed on the exposed surface portion by applying a transparent passivation treatment. Further, a first color layer may be formed on the transparent protective passivation layer by applying a first electrophoretic deposition (e.g., at chamfered edge region 402 as shown in FIG. 4). At 620, 622, and 624, blocks 614, 616, and 618 may be repeated to form a second color layer on a second edge region (e.g., at chamfered edge region 404 as shown in FIG. 4). The second color layer may be different from the first color and the formulation of the fluid used in the electrophoretic deposition of block 618 may be different from the fluid used in block 624.

FIG. 7 illustrates another example process 700 for forming a transparent protective passivation layer and an electrophoretic deposition layer on multiple chamfered edge regions of a metal substrate. At 702, a metal alloy substrate or metal substrate (e.g., magnesium alloy substrate) may be pre-formed. At 704, a first electrophoretic deposition layer may be formed on the metal substrate by applying a first electrophoretic deposition.

At 706, an edge region of the metal substrate may be chamfered by applying water-based anti-corrosion cutting fluid to form an exposed surface portion of the metal substrate. At 708, the exposed surface portion may be cleaned by ultrasonic vibration cleaning. At 710, a transparent protective passivation layer may be formed on the exposed surface portion by applying a transparent passivation treatment. At 712, a second electrophoretic deposition layer may be formed on the transparent protective passivation layer by applying a second electrophoretic deposition. At 714, 716, 718, and 720, blocks 706, 708, 710, and 712 may be repeated to obtain multiple chamfered edge regions on the metal substrate.

In this manner, examples described herein may utilize a water-based anti-corrosion cutting fluid to chamfer metal substrate for obtaining a stabilized metal substrate surface. Thus, electronic device housing may be manufactured with an enhanced and consistent quality using the CNC cutting. Also, example described herein may offer a flexible production arrangement without corrosion concerns on metal substrates.

It may be noted that the above-described examples of the present solution are for the purpose of illustration. Although the solution has been described in conjunction with a specific example thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the examples of any method or process so disclosed, may be combined in any combination, except combinations where at least some of such features and/or examples are mutually exclusive.

The terms “include,” “have,” and variations thereof, as used herein, have the same meaning as the term “comprise” or appropriate variation thereof. Furthermore, the term “based on,” as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A method for manufacturing an electronic device housing, the method comprising:
forming a coating layer on a surface of a metal substrate;
chamfering an edge region of the metal substrate by applying water-based anti-corrosion cutting fluid to form an exposed surface portion of the metal substrate;
forming a transparent protective passivation layer on the exposed surface portion; and
forming a first electrophoretic deposition layer on the transparent protective passivation layer.

2. The method of claim 1, further comprising:
cleaning the exposed surface portion by ultrasonic vibration cleaning prior to forming the transparent protective passivation layer.

3. The method of claim 1, wherein the coating layer is a second electrophoretic deposition layer formed by applying an electrophoretic deposition on the surface of the metal substrate.

4. The method of claim 1, wherein the coating layer is an oxide layer formed by applying one of a micro-arc oxidation treatment and a passivation treatment on the surface of the metal substrate.

5. The method of claim 1, wherein the water based anti-corrosion cutting fluid comprises following components by weight percentage:
alcoholic agent 5-40%;
organic amine 3-15%;
carboxylate salt 5-30%;
surfactant 1-5%; and
water 55-85%.

6. The method of claim 1, wherein the transparent protective passivation layer comprises a complex of a metal ion, an organic add, and a chelating agent.

7. The method of claim 1, wherein the metal substrate comprises aluminum, magnesium, lithium, zinc, titanium, aluminum alloy, magnesium alloy, lithium alloy, zinc alloy, titanium alloy, or combinations thereof.

8. A method of making a casing for an electronic device, the method comprising:
forming an oxide layer on a metal substrate;
applying a paint coating on the metal substrate;
chamfering an edge region of the metal substrate by applying water-based anti-corrosion cutting fluid to form an exposed surface portion of the metal substrate;
applying a transparent passivation treatment on the exposed surface portion to form a transparent protective passivation layer; and
applying an electrophoretic deposition on the transparent protective passivation layer to form an electrophoretic deposition layer.

9. The method of claim 8, wherein the oxide layer is formed on the metal substrate by applying one of a micro-arc oxidation treatment and a passivation treatment.

10. The method of claim 8, wherein applying the paint coating on the metal substrate comprises:
applying a primer coat on an outer surface of the metal substrate;
applying a base coat on the primer coat; and
applying one of an ultraviolet top coat and a thermal-cured polyurethane top coat on the base coat.

11. The method of claim 8, wherein the electrophoretic deposition layer on the chamfered edge region has a color different from that of the oxide layer formed on the surface of the metal substrate.

12. A method of making a casing for an electronic device, the method comprising:
forming a coating layer on a surface of a composite metal substrate;
chamfering an edge region of the composite metal substrate by applying water-based anti-corrosion cutting fluid to form an exposed surface portion of the composite metal substrate;
cleaning the exposed surface portion by applying ultrasonic vibration cleaning;
forming a transparent protective passivation layer on the exposed surface portion; and
forming a color layer on the transparent protective passivation layer by applying electrophoretic deposition.

13. The method of claim 12, further comprising:
applying a paint coating on an outer surface of the composite metal substrate prior to chamfering the edge region of the composite metal substrate, the paint coating comprises a powder coating, a primer coating, a base coating, an ultraviolet top coating, or any combination thereof.

14. The method of claim 12, wherein the coating layer is a micro-arc oxidation layer, a passivation layer, or an electrophoretic deposition layer.

15. The method of claim 12, wherein the color layer on the transparent protective passivation layer has a color different from that of the coating layer formed on the surface of the composite metal substrate.
